(19) United States
(12) Patent Application Publication
(10) Pub. No.: US 2016/0183592 A1
(43) Pub. Date: Jun. 30, 2016

(54) ELECTRONIC CIGARETTE

(71) Applicant: Tuanfang LIU, Ji'an (CN)

(72) Inventor: Tuanfang LIU, Ji'an (CN)

(21) Appl. No.: 14/682,081

(22) Filed: Apr. 8, 2015

(30) Foreign Application Priority Data
Dec. 26, 2014 (CN) 201410825071.5
Dec. 26, 2014 (CN) 201420845547.7

(51) Int. Cl. A24F 47/00; H05B 1/02

(52) U.S. Cl. CPC A24F 47/008; H05B 1/0244

(57) ABSTRACT

An electronic cigarette, including: a detachable atomizer, a housing assembly, a power supply, and a PCBA function control plate. The detachable atomizer is disposed at a top of the electronic cigarette and connected to the housing assembly through screw thread. The housing assembly includes a plurality of slots inside, and the power supply and the PCBA function control plate are disposed in the housing assembly via the slots through tight fit. The power supply includes a replaceable battery, and the replaceable battery is fixed in a stainless steel pipe of the power supply through threaded connection.

### CROSS-REFERENCE TO RELATED APPLICATIONS

Pursuant to 35 U.S.C. §119 and the Paris Convention Treaty, this application claims the benefit of Chinese Patent Application No. 201410825071.5 filed Dec. 26, 2014 and Chinese Patent Application No. 201420845547.7 filed Dec. 26, 2014. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

1. Field of the Invention

The invention relates to an electronic cigarette.

2. Description of the Related Art

The battery of a conventional electronic cigarette is integrated and not meant to be replaceable, which is wasteful.

### SUMMARY OF THE INVENTION

In view of the above existing problem, it is one objective of the invention to provide an electronic cigarette that comprises a replaceable battery.

To achieve the above objective, in accordance with one embodiment of the invention, there is provided an electronic cigarette, comprising: a detachable atomizer, a housing assembly, a power supply, and a PCBA function control plate, wherein the detachable atomizer is disposed at a top of the electronic cigarette and connected to the housing assembly through screw thread; the housing assembly comprises a plurality of slots inside, and the power supply and the PCBA function control plate are disposed in the housing assembly via the slots through tight fit; the power supply comprises a replaceable battery, and the replaceable battery is fixed in a stainless steel pipe of the power supply through threaded connection.

In a class of this embodiment, the power supply comprises an insulation ring, a fixed seat, a joint spring, a battery positive terminal, an upper top cap, the replaceable battery, the stainless steel pipe, a battery bottom cover, a male for the battery bottom cover; the insulation ring, the fixed seat, the joint spring, and the battery positive terminal are assembled as a whole, and then are totally pressed on the upper top cap to form a whole structure; the whole structure is first assembled with the stainless steel pipe and the male for the battery bottom cover through tight fit, and then pressed into a shell of the housing assembly along with the battery; the male for the battery bottom cover is screwed with the battery bottom cover.

In a class of this embodiment, the fixed seat is inserted into the insulation ring from top down; the joint spring is inserted into the insulation ring from bottom up and sheaths the fixed seat, and is tightly pressed in the battery positive terminal; an assembled structure formed by the insulation ring, the fixed seat, the joint spring, and the battery positive terminal is tightly pressed in the upper top cap; the upper top cap is pressed in the stainless steel pipe; the male for the battery bottom cover is tightly pressed in the stainless steel pipe from another end thereof; the male for the battery bottom cover and the stainless steel pipe pass through an outer surface of the upper top cap and are pressed in the hell.

In a class of this embodiment, a detachable atomization core is disposed in the detachable atomizer; the detachable atomization core and the detachable atomizer are connected through screw thread.

In a class of this embodiment, the detachable atomizer comprises an oil seal cover, an upper sealing gasket, an oil storage cup, a lead screw male, a small sealing ring, an atomization rod, a limit cover, an air sealing ring, a lower sealing gasket, a fixed seat for dual heating wires, a first insulation ring, a heating wire joint, a large sealing ring, and a copper base; the lead screw male, the small sealing ring, the atomization rod, the limit cover, the air sealing ring, the fixed seat for dual heating wires, the first insulation ring, and the heating wire joint are assembled in series to form the detachable atomization core; the lead screw male and the limit cover comprise external screw thread, so that the assembled detachable atomization core comprises male screw threads at both ends; the seal cover, the upper sealing gasket, the oil storage cup, the lower sealing gasket, the large sealing ring, and the copper base are sheathed with one another to form an oil storage body; the copper base is assembled with the lower sealing gasket, and then is put into the oil storage cup; and the seal cover, the upper sealing gasket, the oil storage cup, the lower sealing gasket, and the copper base are connected via the screw threads of the assembled detachable atomization core.

In a class of this embodiment, heating wires, tobacco cotton, and cotton wool are placed in the fixed seat for dual heating wires, and the fixed seat, the first insulation ring, and the heating wire joint are integrated.

In a class of this embodiment, the housing assembly comprises an internal copper piece, a lower contact, a second insulation ring, the shell, and a bottom case; the internal copper piece, the lower contact, and the second insulation ring are assembled and pressed in a center hole of the shell; the shell and the bottom case are connected via a tapping screw; and the bottom case is fixed at a bottom of the shell via the tapping screw.

In a class of this embodiment, the PCBA function control plate comprises a control plate, a LED display light, and an air switch; electronic components are soldered on the control plate; the LED display light is patched on a PCB; the air switch is soldered on the PCB via a lead wire, whereby forming the PCBA function control plate.

In a class of this embodiment, the PCBA function control plate is inserted in the slots of the shell and fits tightly with the shell; the PCBA function control plate is a rectangle double-layered PCB plate with patched electronic components and a microUSB socket; the PCBA function control plate is pressed by the bottom case against the slots thereby being sealed in the housing assembly.

In a class of this embodiment, the PCBA function control plate is tightly pressed in the shell; after the power supply and the PCBA function control plate are assembled, the bottom case and the shell are connected using a tapping screw.

Advantages of the invention are summarized as follows.

1. The power supply of the electronic cigarette is detachable so it is replaceable thereby saving the utilization cost of the electronic cigarette;

2. The atomizer of the electronic cigarette is detachable so the electronic cigarette is economic; and

3. The oil storage cup is transparent, so the remaining oil can be observed, which ensure the safe utilization of the electronic cigarette.

### BRIEF DESCRIPTION OF THE DRAWINGS

FIG. 1 is a front view of an electronic cigarette according to one embodiment of the invention;

FIG. 2 is a stereograph of an electronic cigarette according to one embodiment of the invention;

FIG. 3 is a cross sectional view of an electronic cigarette according to one embodiment of the invention; and

FIG. 4 is an exploded view of an electronic cigarette according to one embodiment of the invention.

### DETAILED DESCRIPTION OF THE EMBODIMENTS

For further illustrating the invention, experiments detailing an electronic cigarette are described below. It should be noted that the following examples are intended to describe and not to limit the invention.

The invention provides an electronic cigarette that comprises detachable components, so the electronic cigarette is not disposable, which saves the utilization costs.

The electronic cigarette comprises: a detachable atomizer, a housing assembly, a power supply, and a PCBA function control plate, wherein the detachable atomizer is disposed at a top of the electronic cigarette and connected to the housing assembly through screw thread; the housing assembly comprises a plurality of slots inside, and the power supply and the PCBA function control plate are disposed in the housing assembly via the slots through tight fit. The detachable atomizer comprises screw threads at both ends thereof, and the battery comprises a bottom cover which can be screwed off, both of which benefit the detachment of the electronic cigarette.

Preferably, the detachable atomizer comprises a detachable atomization core comprising hardwares, resistance heating wires, silicon products, tobacco cotton, and cotton wool, sealed silica gel, a glass oil cup, and a copper connector. All these components are assembled via screw thread to form a detachable atomizer. The transparent glass oil cup enables the consumers to know the remaining amount of the smoke oil.

Preferably, the housing assembly comprises a shell, a bottom case, connection hardwares, silica gel, and a tapping screw. The shell and the bottom case are connected via the tapping screw. The hardwares tightly fits the shell. The silica gel operates to seal and insulate. Thus, the housing assembly has a concise and beautiful appearance.

Preferably, the power supply comprises the battery, a battery bottom cover, a stainless steel pipe, insulation rings and hardwares. The battery is replaceable and screwed into the bottom cover. That the battery is detachable and the oil storage cup is transparent allows the users to know the usage state of the battery and the remaining amount of the smoke oil, thereby ensuring the safe and economic application of the electronic cigarette.

The PCBA function control plate comprises a control plate, a LED display light, and an air switch. The LED display light can indicate the power-on state of the power supply, the working state of the battery, the low voltage state of the battery, and the discharging state of the battery.

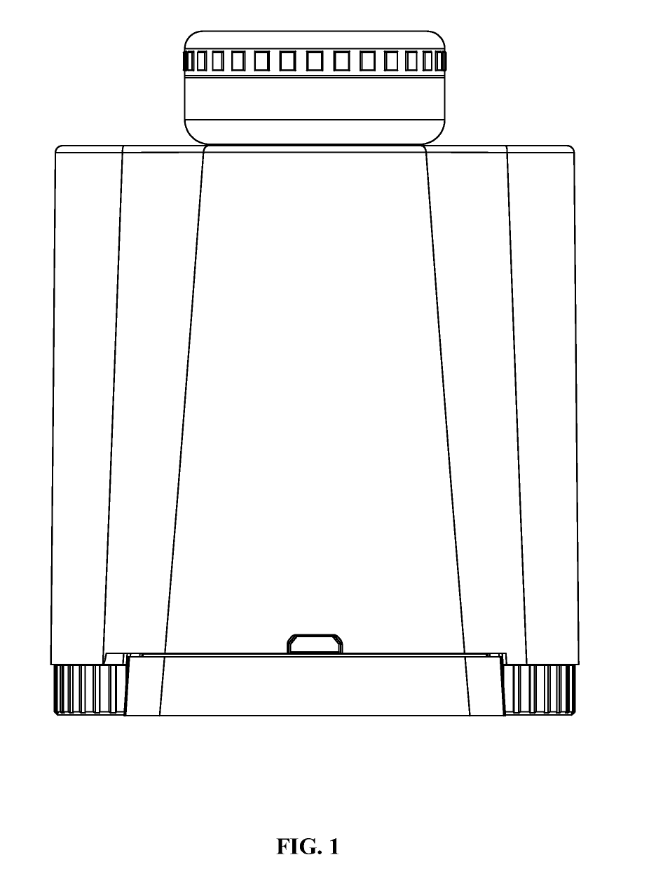

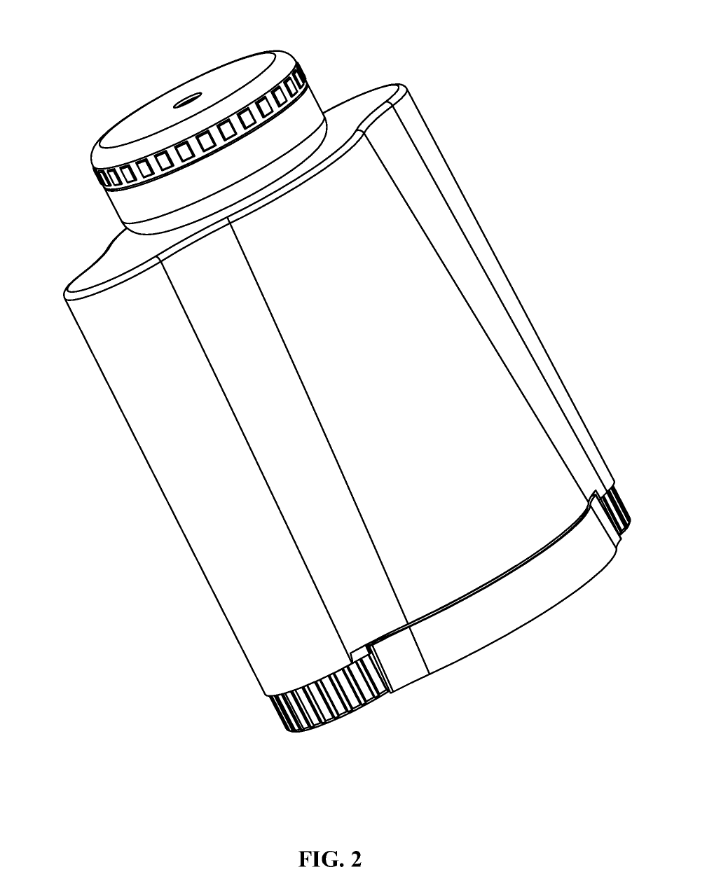

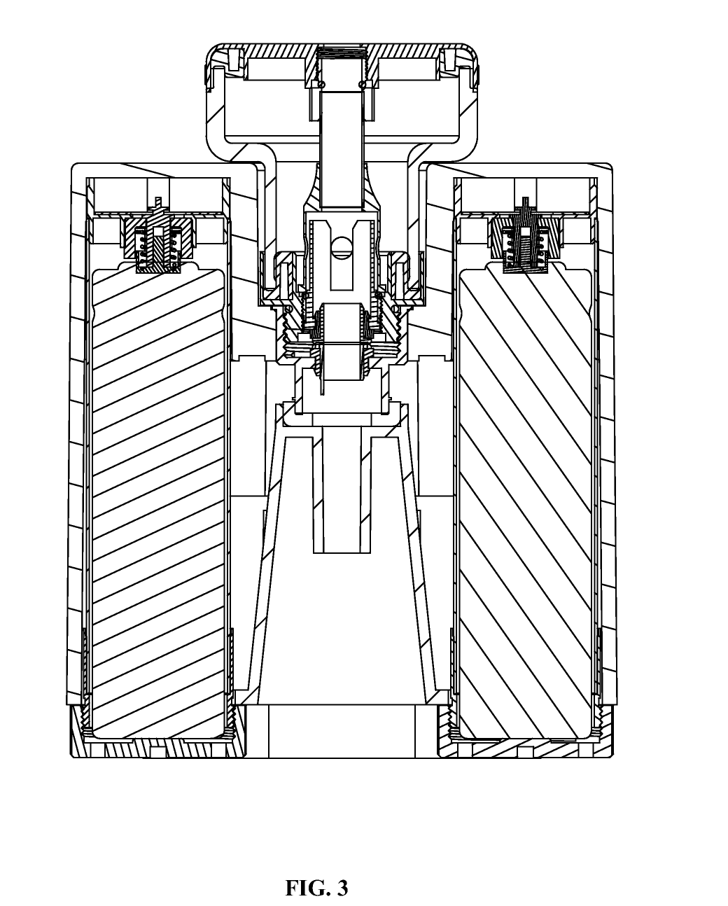

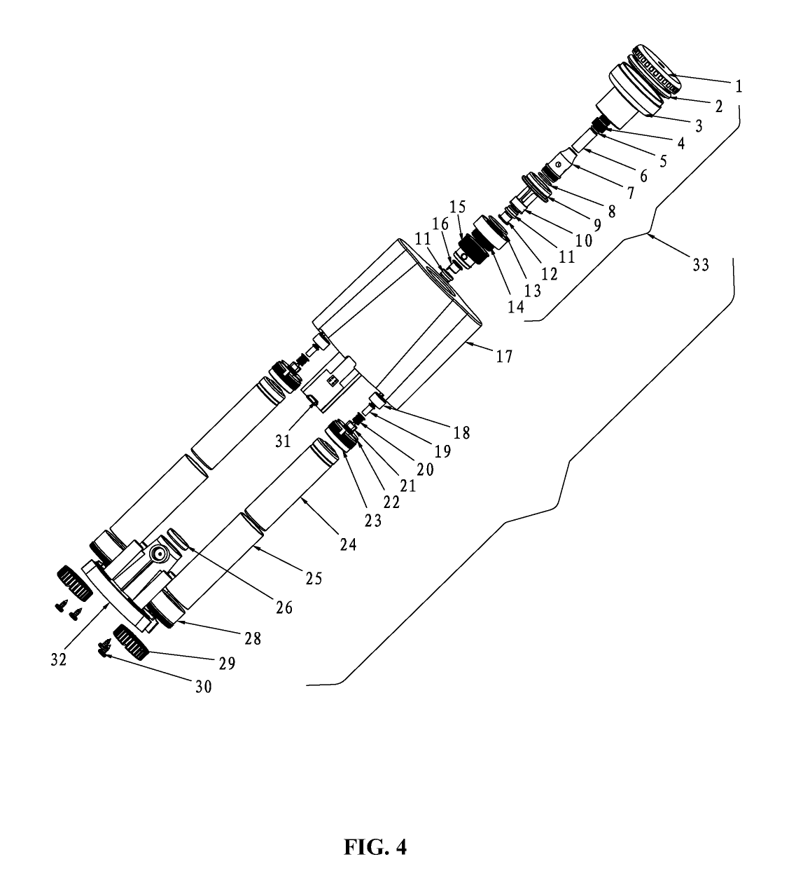

As shown in FIGS. 1-4, the electronic cigarette comprises a detachable atomizer 33 comprising an oil seal cover 1, an upper sealing gasket 2, an oil storage cup 3, a lead screw male 4, a small sealing ring 5, an atomization rod 6, a limit cover 7, an air sealing ring 8, a lower sealing gasket 9, a fixed seat 10 for dual heating wires, a first insulation ring 11, a heating wire joint 12, a large sealing ring 13, and a copper base 14; a housing assembly, comprising an internal copper piece 15, a lower contact 16, a second insulation ring 27, the shell 17, and a bottom case 32; a power supply, comprising an insulation ring 18, a fixed seat 19, a joint spring 20, a battery positive terminal 21, an upper top cap 23, the replaceable battery 24, the stainless steel pipe 25, a battery bottom cover 29, a male 28 for the battery bottom cover; a PCBA function control plate 31 comprising a control plate, a LED display light, and an air switch; a first rubber gasket 22 and a second rubber gasket 26.

Specifically, the invention provides an electronic cigarette, comprising: a detachable atomizer, a housing assembly, a power supply, and a PCBA function control plate, wherein the detachable atomizer is disposed at a top of the electronic cigarette and connected to the housing assembly through screw thread; the housing assembly comprises a plurality of slots inside, and the power supply and the PCBA function control plate are disposed in the housing assembly via the slots through tight fit; the power supply comprises a replaceable battery, and the replaceable battery is fixed in a stainless steel pipe of the power supply through threaded connection.

The power supply comprises an insulation ring 18, a fixed seat 19, a joint spring 20, a battery positive terminal 21, an upper top cap 23, the replaceable battery 24, the stainless steel pipe 25, a battery bottom cover 29, a male 28 for the battery bottom cover; the insulation ring 18, the fixed seat 19, the joint spring 20, and the battery positive terminal 21 are assembled as a whole, and then are totally pressed on the upper top cap to form a whole structure; the whole structure is first assembled with the stainless steel pipe 25 and the male 28 for the battery bottom cover through tight fit, and then pressed into a shell 17 of the housing assembly along with the battery; the male 28 for the battery bottom cover is screwed with the battery bottom cover 29.

The fixed seat 19 is inserted into the insulation ring 18 from top down; the joint spring 20 is inserted into the insulation ring 18 from bottom up and sheaths the fixed seat 19, and is tightly pressed in the battery positive terminal 21; an assembled structure formed by the insulation ring 18, the fixed seat 19, the joint spring 20, and the battery positive terminal 21 is tightly pressed in the upper top cap 23; the upper top cap 23 is pressed in the stainless steel pipe 25; the male 28 for the battery bottom cover is tightly pressed in the stainless steel pipe 25 from another end thereof; the male 28 for the battery bottom cover and the stainless steel pipe 25 pass through an outer surface of the upper top cap 23 and are pressed in the hell 17.

A detachable atomization core is disposed in the detachable atomizer; the detachable atomization core and the detachable atomizer are connected through screw thread.

The detachable atomizer 33 comprises an oil seal cover 1, an upper sealing gasket 2, an oil storage cup 3, a lead screw male 4, a small sealing ring 5, an atomization rod 6, a limit cover 7, an air sealing ring 8, a lower sealing gasket 9, a fixed seat 10 for dual heating wires, a first insulation ring 11, a heating wire joint 12, a large sealing ring 13, and a copper base 14; the lead screw male 4, the small sealing ring 5, the atomization rod 6, the limit cover 7, the air sealing ring 8, the fixed seat 10 for dual heating wires, the first insulation ring 11, and the heating wire joint 12 are assembled in series to form the detachable atomization core.

The lead screw male 4 and the limit cover 7 comprise external screw thread, so that the assembled detachable atomization core comprises male screw threads at both ends.

The seal cover 1, the upper sealing gasket 2, the oil storage cup 3, the lower sealing gasket 9, the large sealing ring 13, and the copper base 14 are sheathed with one another to form an oil storage body; the copper base 14 is assembled with the lower sealing gasket 9, and then is put into the oil storage cup 3.

The seal cover 1, the upper sealing gasket 2, the oil storage cup 3, the lower sealing gasket 9, and the copper base 14 are connected via the screw threads of the assembled detachable atomization core.

Heating wires, tobacco cotton, and cotton wool are placed in the fixed seat 10 for dual heating wires, and the fixed seat, the first insulation ring 11, and the heating wire joint 12 are integrated.

The housing assembly comprises an internal copper piece 15, a lower contact 16, a second insulation ring 27, the shell 17, and a bottom case 32; the internal copper piece 15, the lower contact 16, and the second insulation ring 27 are assembled and pressed in a center hole of the shell 17; the shell 17 and the bottom case 32 are connected via a tapping screw; and the bottom case 32 is fixed at a bottom of the shell 17 via the tapping screw.

The PCBA function control plate 31 comprises a control plate, a LED display light, and an air switch; electronic components are soldered on the control plate; the LED display light is patched on a PCB; the air switch is soldered on the PCB via a lead wire, whereby forming the PCBA function control plate 31.

The PCBA function control plate is inserted in the slots of the shell and fits tightly with the shell; the PCBA function control plate is a rectangle double-layered PCB plate with patched electronic components and a microUSB socket; the PCBA function control plate is pressed by the bottom case 32 against the slots thereby being sealed in the housing assembly.

The PCBA function control plate is tightly pressed in the shell 17; after the power supply and the PCBA function control plate are assembled, the bottom case 32 and the shell are connected using a tapping screw 30.

The electronic cigarette is summarized as follows.

The detachable atomizer: firstly, the heating wires and tobacco cotton are placed in the fixed seat 10 for dual heating wires, and the fixed seat, the first insulation ring 11, and the heating wire joint 12 are integrated. Thereafter, the lead screw male 4, the atomization rod 6 and the limit cover 7 are pressed as a whole. The above two combinations are pressed to form the detachable atomization core. The copper base 14 is assembled with the lower sealing gasket 9, and then is put into the oil storage cup 3. The seal cover 1 and the upper sealing gasket 2 are connected via the screw threads of the assembled detachable atomization core.

The housing assembly: the internal copper piece 15, the lower contact 16, and the first insulation ring 11 are assembled and pressed in the shell 17; the shell 17 and the bottom case 32 are connected via a tapping screw; and the bottom case 32 is fixed at a bottom of the shell 17 via the tapping screw 30.

The power supply: the insulation ring 18, the fixed seat 19, the joint spring 20, and the battery positive terminal 21 are assembled as a whole, and then are totally pressed on the upper top cap to form a whole structure; the whole structure is first assembled with the stainless steel pipe 25 and the male 28 for the battery bottom cover through tight fit, and then pressed into a shell 17 of the housing assembly along with the battery; the male 28 for the battery bottom cover is screwed with the battery bottom cover 29.

The PCBA function control plate: the electronic components, the LED display light and the air switch are soldered on the control plate to form the PCBA function control plate.

The power supply and the PCBA function control plate are tightly pressed in the shell. After the assembly of the power supply and the PCBA function control plate, the bottom case and the shell are connected via the tapping screw 30.

The objective of the invention is to provide an electronic cigarette that comprises detachable power supply, detachable atomizer and transparent oil storage cup.

Advantages of the example is summarized as follows:

1. The power supply of the electronic cigarette is detachable so it is replaceable and the electronic cigarette is economic;

2. The atomizer of the electronic cigarette is detachable so the electronic cigarette is economic; and

3. The oil storage cup is transparent, so the remaining oil can be observed, which ensure the safety of the electronic cigarette.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An electronic cigarette, comprising:
a) a detachable atomizer;
b) a housing assembly;
c) a power supply; and
d) a PCBA function control plate;
wherein
the detachable atomizer is disposed at a top of the electronic cigarette and connected to the housing assembly through screw thread;
the housing assembly comprises a plurality of slots inside, and the power supply and the PCBA function control plate are disposed in the housing assembly via the slots by means of tight fit;
the power supply comprises a replaceable battery, and the replaceable battery is fixed in a stainless steel pipe of the power supply through threaded connection.

2. The electronic cigarette of claim 1, wherein the power supply comprises an insulation ring, a fixed seat, a joint spring, a battery positive terminal, an upper top cap, the replaceable battery, the stainless steel pipe, a battery bottom cover, a male for the battery bottom cover; the insulation ring, the fixed seat, the joint spring, and the battery positive terminal are assembled as a whole, and then are totally pressed on the upper top cap to form a whole structure; the whole structure is first assembled with the stainless steel pipe and the male for the battery bottom cover through tight fit, and then pressed into a shell of the housing assembly along with the battery; the male for the battery bottom cover is screwed with the battery bottom cover.

3. The electronic cigarette of claim 2, wherein the fixed seat is inserted into the insulation ring from top down; the joint spring is inserted into the insulation ring from bottom up and sheaths the fixed seat, and is tightly pressed in the battery positive terminal; an assembled structure formed by the insulation ring, the fixed seat, the joint spring, and the battery positive terminal is tightly pressed in the upper top cap; the upper top cap is pressed in the stainless steel pipe; the male for the battery bottom cover is tightly pressed in the stainless steel pipe from another end thereof; the male for the battery bottom cover and the stainless steel pipe pass through an outer surface of the upper top cap and are pressed in the hell.

4. The electronic cigarette of claim 2, wherein a detachable atomization core is disposed in the detachable atomizer; the detachable atomization core and the detachable atomizer are connected through screw thread.

5. The electronic cigarette of claim 4, wherein
the detachable atomizer comprises an oil seal cover, an upper sealing gasket, an oil storage cup, a lead screw male, a small sealing ring, an atomization rod, a limit cover, an air sealing ring, a lower sealing gasket, a fixed seat for dual heating wires, a first insulation ring, a heating wire joint, a large sealing ring, and a copper base; the lead screw male, the small sealing ring, the atomization rod, the limit cover, the air sealing ring, the fixed seat for dual heating wires, the first insulation ring, and the heating wire joint are assembled in series to form the detachable atomization core;
the lead screw male and the limit cover comprise external screw thread, so that the assembled detachable atomization core comprises male screw threads at both ends;
the seal cover, the upper sealing gasket, the oil storage cup, the lower sealing gasket, the large sealing ring, and the copper base are sheathed with one another to form an oil storage body; the copper base is assembled with the lower sealing gasket, and then is put into the oil storage cup; and
the seal cover, the upper sealing gasket, the oil storage cup, the lower sealing gasket, and the copper base are connected via the screw threads of the assembled detachable atomization core.

6. The electronic cigarette of claim 5, wherein heating wires, tobacco cotton, and cotton wool are placed in the fixed seat for dual heating wires, and the fixed seat, the first insulation ring, and the heating wire joint are integrated.

7. The electronic cigarette of claim 5, wherein the housing assembly comprises an internal copper piece, a lower contact, a second insulation ring, the shell, and a bottom case; the internal copper piece, the lower contact, and the second insulation ring are assembled and pressed in a center hole of the shell; the shell and the bottom case are connected via a tapping screw; and the bottom case is fixed at a bottom of the shell via the tapping screw.

8. The electronic cigarette of claim 1, wherein the PCBA function control plate comprises a control plate, a LED display light, and an air switch; electronic components are soldered on the control plate; the LED display light is patched on a PCB; the air switch is soldered on the PCB via a lead wire, whereby forming the PCBA function control plate.

9. The electronic cigarette of claim 8, wherein the PCBA function control plate is inserted in the slots of the shell and fits tightly with the shell; the PCBA function control plate is a rectangle double-layered PCB plate with patched electronic components and a microUSB socket; the PCBA function control plate is pressed by the bottom case against the slots thereby being sealed in the housing assembly.

10. The electronic cigarette of claim 1, wherein the PCBA function control plate is tightly pressed in the shell; after the power supply and the PCBA function control plate are assembled, the bottom case and the shell are connected using a tapping screw.
